(19) United States
(12) Patent Application Publication
(10) Pub. No.: US 2011/0246932 A1
(43) Pub. Date: Oct. 6, 2011

(54) System and Method for Configuring Electronic Stamps

(76) Inventors: Craig Ronald Van Roy, Los Gatos, CA (US); Claudia Rodica Charlier, Garner, NC (US)

(21) Appl. No.: 13/073,411

(22) Filed: Mar. 28, 2011

Related U.S. Application Data
(60) Provisional application No. 61/319,587, filed on Mar. 31, 2010.

(51) Int. Cl. G06F 3/048

(52) U.S. Cl. 715/780; 715/835

(57) ABSTRACT

A method and system for configuring electronic stamps is disclosed. In an exemplary embodiment, a user interface enables a user to create or edit an electronic stamp configuration by displaying electronic stamp characteristics and receiving corresponding electronic stamp characteristic selections. The electronic stamp characteristics include stamp placement characteristics, stamp content characteristics, and stamp identification characteristics. The electronic stamp characteristic selections are stored in a database or other data storage structure so as to define the electronic stamp configuration. Preferably, the electronic stamp configuration is used to generate an electronic stamp to be applied to a document in electronic form.

### CROSS-REFERENCE TO RELATED APPLICATIONS

This application is based on and claims priority to U.S. Provisional Application Ser. No. 61/319,587, filed on Mar. 31, 2010, which is incorporated herein by reference in its entirety.

### STATEMENT REGARDING FEDERALLY SPONSORED RESEARCH OR DEVELOPMENT

Not applicable.

### BACKGROUND OF THE INVENTION

When a document providing or requesting information is received by an entity or institution, such as a secretary of state office, certain information about that document, such as filing time and date, is captured. If a paper document is submitted, the information may be captured by manual entry or using, optical scanning technologies known in the art, such as optical character recognition (OCR); if a document is, transmitted or generated electronically, the information may be captured during the submission process, automatically generated upon receipt or creation of the electronic document, by manual entry, or by using OCR. Regardless of the submission method, an electronic version of the document is typically made available to the appropriate office personnel for processing, which may include verification, recordation, or order/request fulfillment.

Traditionally, office personnel would manually stamp a document to indicate its verification status or the level of completion of an underlying task. Alternatively, a separate document indicating verification or completion status could be generated and then affixed to or associated with (physically or electronically) the original document. More recently, software has been used to apply an electronic stamp to a document indicating its verification status or level of completion. As is known in the art, the electronic stamp is generally an overlay to a scanned image of a paper document or can be embedded in an electronic document. Although this software eliminates the need for manual stamping or generating a second document, it does not accommodate an office that processes a variety of documents, each requiring a unique stamp configuration that can change from day-to-day. Moreover, this software is hard coded to place the electronic stamp in a single location and, thus, it is inevitable that some documents will not have white space in that location and the electronic stamp will obstruct part of the information in the document.

### BRIEF SUMMARY OF THE INVENTION

A system and method for configuring one or more electronic stamps to be applied to documents in electronic form is disclosed. In an exemplary embodiment, the system includes at least one application server in communication with at least one database server. The application server provides a user interface that enables a user to create or edit an electronic stamp configuration. To do so, the user interface displays a variety of electronic stamp characteristics and receives the user's selection for each electronic stamp characteristic. The electronic stamp characteristic elections are stored in a database on the database server so as to define the electronic stamp configuration.

The electronic stamp characteristics include characteristics relating to placement of the electronic stamp, the content of the electronic stamp and associated formatting, and the identification of the electronic stamp. The stamp placement characteristics include stamp height, stamp width, page number of a document on which the electronic stamp is to appear, and location in which the electronic stamp is to appear on a page of a document. The stamp content characteristics include office designation, name, file number, document number, invoice number, receipt number, arrival date, arrival time, filing date, filing time, registration number, application number, registration date, renewal date, relevant individual or entity name, expiration date, notes, border width, and border type. The formatting characteristics associated with the stamp content characteristics include font, font size, font style, line on which the content characteristic is to appear in an electronic stamp, position in which the content characteristic is to appear in a line in an electronic stamp, and alignment options. The stamp identification characteristics include stamp name, office in which, an electronic stamp is to be used, line of business in which an electronic stamp is to be used, and document type on which an electronic stamp is to be used. Preferably, the user interface displays a summary of the electronic stamp configuration that includes one or more electronic stamp characteristics and associated electronic stamp characteristic selections.

In another aspect of the invention, the application server uses the electronic stamp configuration to generate an electronic stamp that is applied to a document in electronic form. A document database is also provided on the database server to store information about a document, such as office, designation, name, file number, document number, invoice number, receipt number, arrival date, arrival time, filing date, filing time, registration number, application number, registration date, renewal date, relevant individual or entity name, expiration date, and notes. The application server retrieves document information corresponding to certain electronic stamp characteristic selections from the document database and incorporates the document information into the electronic stamp in accordance with the electronic stamp configuration.

### BRIEF DESCRIPTION OF THE DRAWINGS

FIG. 1 is a diagram of a system for configuring electronic stamps and applying such stamps to documents in accordance with an exemplary embodiment of the present invention.

FIG. 2 is a process flow diagram of an exemplary method for configuring electronic stamps using the system of FIG. 1.

FIGS. 3-4 are exemplary screen shots of the display device of FIG. 1 during the electronic stamp configuration process.

FIG. 5 is a process flow diagram of an exemplary method for applying electronic stamps to documents using the system of FIG. 1.

FIGS. 6-8 are exemplary screen shots of the display device of FIG. 1 during the application process.

### DETAILED DESCRIPTION OF EXEMPLARY EMBODIMENT

The present invention is directed to a system and method for configuring electronic stamps and applying such stamps to documents filed with or processed by a particular organization or office, such as a secretary of state office. While the invention will be described in detail below with reference to an exemplary embodiment, it should be understood that the invention is not limited to the specific system configuration or methodology of this embodiment. In addition, although the exemplary embodiment is described as embodying several different inventive features, one skilled in the art will appreciate that any one of these features could be implemented without the others in accordance with the invention.

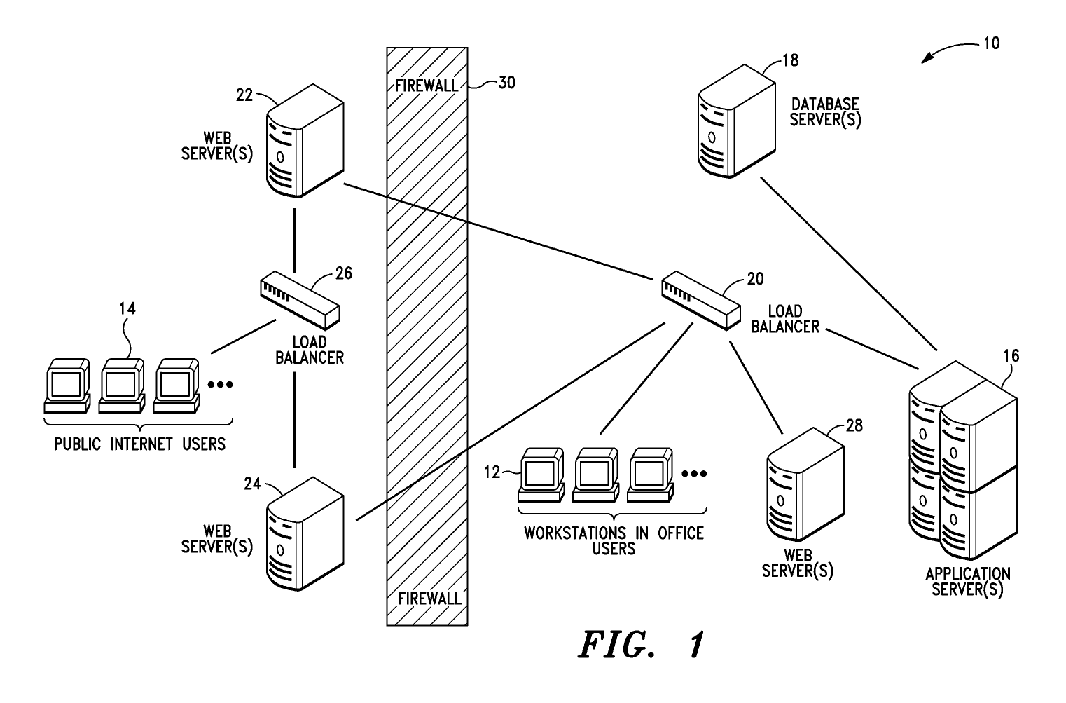

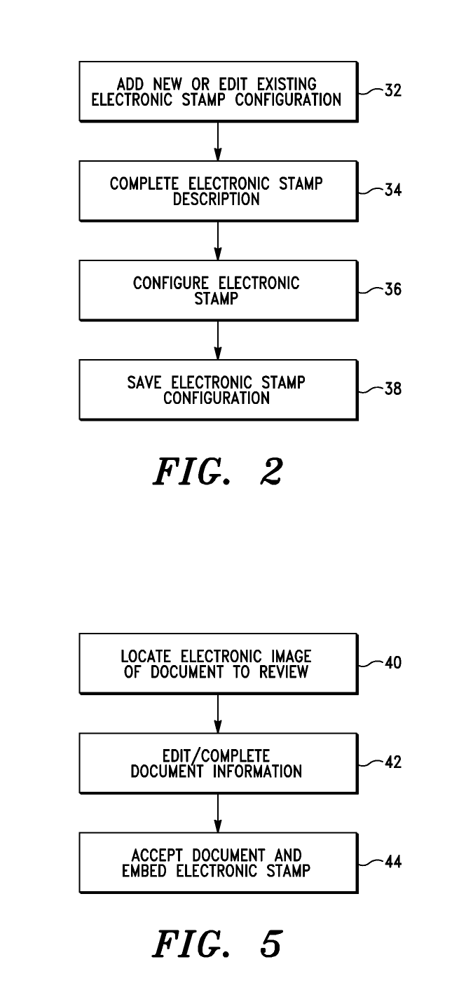

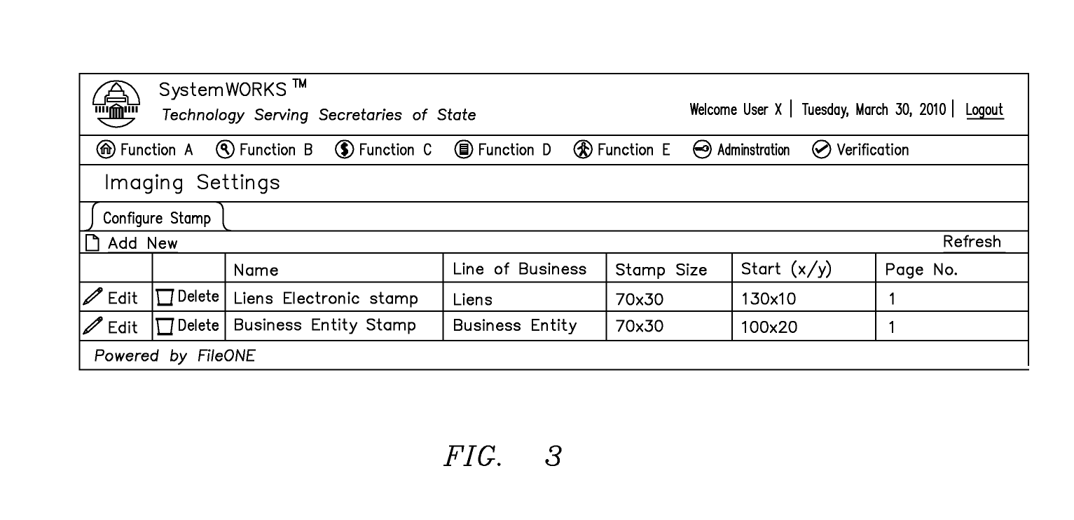

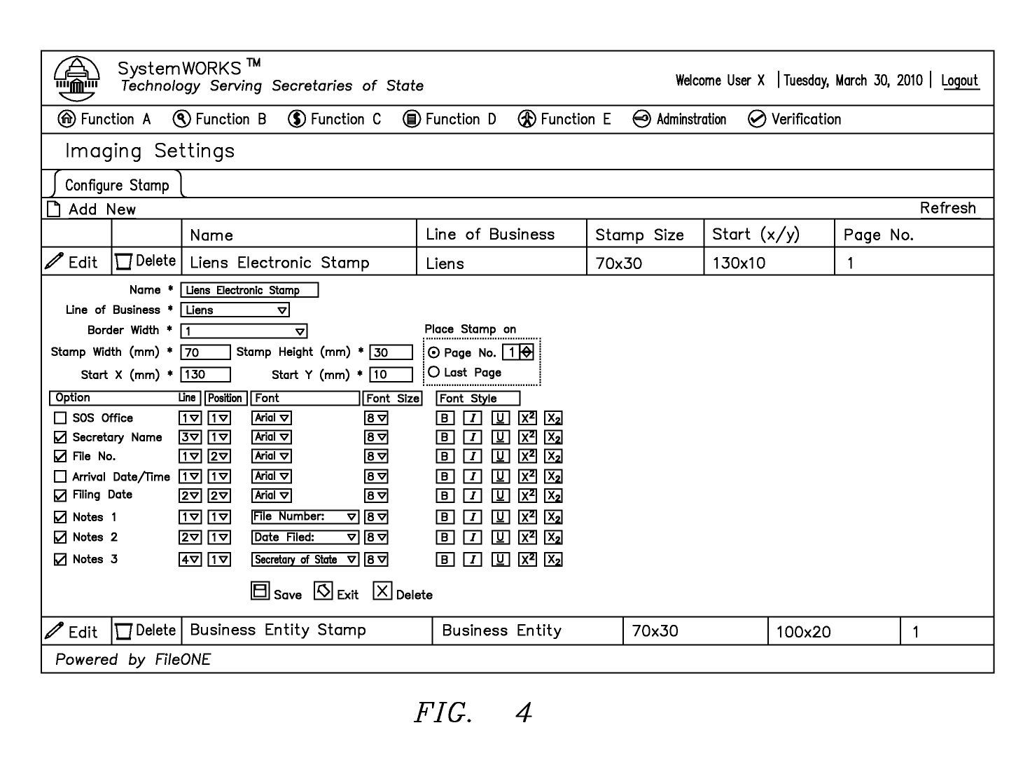

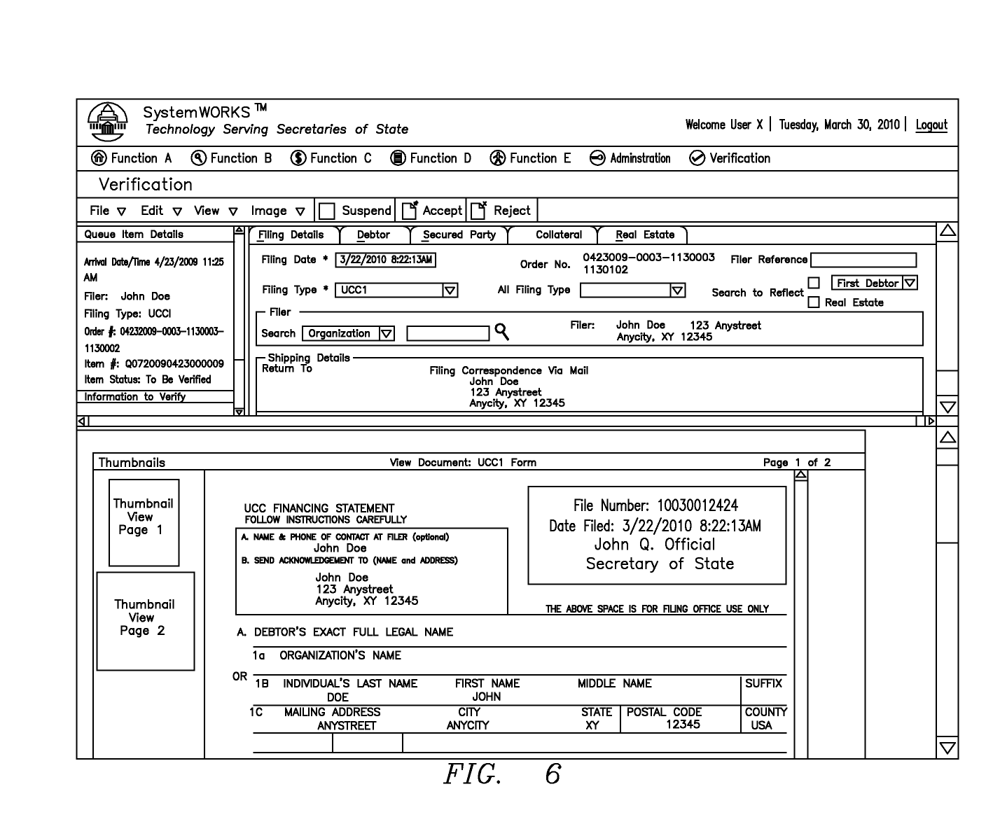

Referring to FIG. 1, a system in accordance with an exemplary embodiment of the present invention is shown generally as reference, numeral 10. System 10 includes one or more workstations 12 for use by workers located in an office, such as a secretary of state office. Workstations 12 may, comprise any suitable computing device (such as a programmed general purpose computer, a special purpose computer, or the like). One or more peripheral devices may also be provided, such as a standard keyboard, a mouse, a scanner, a barcode reader for scanning the barcode on a paper filing or other paper document, a magnetic stripe reader for scanning identification or access cards (such as employee identification/access cards used for security purposes), and/or a printer for printing a document that has been electronically stamped in accordance with the present invention. System 10 also includes computers 14 used by external workers or other users who are permitted to access the system from a remote location using public Internet and VPN technologies known in the art.

System 10 also includes one or more centralized application servers 16 each of which hosts and runs one or more applications in accordance with the present invention. One application presents a user interface to enable a user to create or edit electronic stamp configurations, as described below in connection with FIGS. 2-4. Another application enables a user to apply electronic stamps, to documents, as described below in connection with FIGS. 5-8. For simplicity, the term “application server” as used herein means both the hardware (i.e., any computing device in which a processor is operable to execute computer-readable instructions stored on a computer-readable medium) and the application(s) that reside thereon.

System 10 further includes one or more centralized database servers 18 each of which stores various types, of data, such as electronic stamp configurations, electronic images of filed documents, information associated with the filed documents, and other information relevant to electronic stamp configurations such as the names of individuals and the positions they hold. For simplicity, the term “database server” as used herein means both the hardware (i.e., any storage device or memory operable to store and provide access to data) and the data stored therein. It should be understood that the data may be stored in a database or any other type of data storage structure known in the art. For example, all or a portion of the data may be stored as a variable on the system in files of various types, such as XML files, flat files, fixed length files, delimited files, batch files, application configuration files, and a wide variety of other file types known in the art.

Several types of computer network connections may be used to network the various components of system 10, including a local are network (LAN), a wide area network (WAN), and other network, topologies known in the art. In the illustrated example, a load balancer/router 20 functions to route network traffic between workstations 12 and the application servers 16 and database servers 18. In addition, remote computers 14 located outside of the network access the application servers 16 and database servers 18 through external web servers 22 and 24 and a load balancer/router 26 that, are connected to an internal web server 28 through any suitable firewall 30. Alternatively, remote computers 14 could access the application servers 16 and database servers 18 directly through firewall 30 (via an appropriate network configuration), through a series of external web servers, through a VPN connection, or through any other technologies known in the art.

System 10 described above and shown in FIG. 1 is merely an example of a network architecture that may be used to implement the present invention. One skilled in the art will understand that other network architectures, may also be used, including a more decentralized model in which the application servers and/or database servers are only accessible from specific workstations or where the functionality is distributed so that it actually resides on the client workstations in a client application type of model. Also, the application servers and database servers may be replaced with one or more servers that perform both the application and data storage functions described above. Thus, the system may be implemented with any number of servers without departing from the scope of the present invention.

Referring now to FIG. 2, a process flow diagram that shows an exemplary method of configuring an electronic stamp using system 10 of FIG. 1 is provided. Preferably, an electronic stamp is initially configured by an administrator so that the electronic stamp configuration is in accordance with organization policy and rules with respect to the electronic stamp's placement and content. At block 32, the software residing on application server(s) 16 presents a user interface that enables the administrator (e.g., via one of workstations 12 or remote computers 14) to either add a new electronic stamp configuration to a database on database server(s) 18 or edit an existing electronic stamp configuration stored in a database on database server(s) 18.

An exemplary “configure stamp” summary screen that is displayed on the administrator's, display screen when in the “Administration” function is shown in FIG. 3. From this screen, the administrator may choose to create a new electronic stamp configuration by selecting an “Add New” button or may edit an existing electronic stamp configuration by selecting an “Edit” button associated with an existing electronic stamp configuration. The button in this context, and as, the term is used throughout the specification, may be any shape, including a pencil shape as shown in FIG. 3. Alternatively, any other method known in the art such as a hyperlink, voice command, or set of keyboard commands, may be used to execute the desired feature. The administrator may also delete an existing electronic stamp configuration by selecting a “Delete” button such as a trash receptacle icon as shown in FIG. 3.

As will be described below, when the administrator creates a new electronic stamp configuration or edits an existing electronic stamp configuration, she makes selections for various characteristics of the electronic stamp configuration (referred to as “electronic stamp characteristics” and “electronic stamp characteristic selections”). The electronic stamp characteristics include information on the size of the electronic stamp and location at which the electronic stamp is to be applied to a document (referred to as “stamp placement characteristics”), information on the content of the electronic stamp (referred to as “stamp content characteristics”), and information that allows a user to identify the electronic stamp configuration (referred to as “stamp identification characteristics”).

The screen shown in FIG. 3 displays summaries of various electronic stamp configurations currently stored in a database on database server(s) 18. Each summary includes the administrator's selections for certain stamp identification characteristics and certain stamp placement characteristics. The stamp identification characteristics include the stamp's name and the line of business in which the stamp is to be used. The stamp placement characteristics include the size of the stamp, the page number of a document on which the stamp is to be applied, and the starting (x, y) coordinates on a document page where the stamp is to be applied. Of course, it should be understood that the summaries may include any or all of the electronic stamp characteristics associated with the electronic stamp, configurations stored in a database on database server(s) 18.

Referring back to FIG. 2 at block 34, the administrator completes a description of the electronic stamp configuration by making selections for each of the stamp identification characteristics. An exemplary “configure stamp” detail screen that may be displayed on the administrator's display screen is shown in FIG. 4. As can be seen, the stamp identification characteristics include a name of the electronic stamp configuration and the line of business in which the electronic stamp configuration is to be used. The stamp identification characteristics may also include, without limitation, the office in which the electronic stamp is to be used and the document type on which the electronic stamp is to be used.

Electronic stamp configurations may be created for all documents in a certain line of business, such as all documents relating to liens, business entities, trademarks, or taxes. Alternatively, electronic stamp, configurations may be created for each different document type within a line of business. For example, in the trademark line of business, different electronic stamp configurations could be created for applications, registration certificates, fee payments, and renewal documents. Of course, in the most basic form, a single electronic stamp configuration may be created and used on all documents filed with or processed by a particular office or organization. When multiple electronic stamp configuration levels are created (i.e., a default configuration, at least one line of business configuration, and at least one document type configuration), preferences may be set to determine, which level of electronic stamp configuration should take precedence and be applied to a particular document type. For example, an office preference may be that the default stamp is applied unless there is a document type configuration available, or in, another example, a line of business level stamp is applied unless there is a document type configuration available.

With reference to FIG. 2 at block 36, the administrator next defines the content of the electronic stamp by making selections for each of the stamp content characteristics, and, defines the size and location of the electronic stamp by making selections for each of the stamp placement characteristics. As shown in the exemplary “configure stamp” detail screen in FIG. 4, the stamp placement characteristics include: stamp width; stamp height, the starting (x,y) coordinates for the stamp location on a document page; and the page number on which the stamp is to be applied within a document. The stamp content characteristics include: border width; office, agency, or business designation; elected official, president, or, other employee/agent name; file number; arrival date; arrival time; filing date; and the number and content of notes, i.e., customizable lines of text, to be included in the electronic stamp. Additional stamp content characteristics may include border type, document number, invoice number, receipt number, filing time, registration number, application number, registration date, relevant individual or entity name(s), such as that of a party that filed or submitted the document or rendered payment for the document, and expiration date. Still other stamp content characteristics may be provided depending on the specific type of business or organization in which system 10 is being used. In the case of a secretary of state office, additional configurable stamp content characteristics may include: trademark registration number; notary commission number; document identification code; acceptance date and time; verification or processing status; filing or document processing effective dates; processor or reviewer name or other identifier; docket number; internal client number; or case number.

As shown in FIG. 4, the administrator is also able to define a variety of formatting characteristics associated with each of the stamp content characteristics. The formatting characteristics include, without limitation, the line on which the stamp content characteristic selection is to, appear, the position in which the stamp content characteristic selection is to appear in a line in the electronic stamp, font, font size, and font style, i.e., bold, italic, underline, superscript, or subscript. Additional formatting characteristics may include alignment options such as left, right, center, or justified.

With further reference to FIG. 4, a variety of ways for receiving electronic stamp characteristic selections are provided. As shown in association with the stamp identification characteristic “Line of Business,” the stamp placement characteristic “Page No.,” the stamp content characteristics “Border Width,” “Notes 1,” Notes. 2,” and “Notes 3” and the formatting characteristics “Line,” “Position,” “Font,” and “Font Size,” predetermined options are provided in a drop down menu when the button, such as a down arrow icon, is actuated. The user then makes a selection by choosing one of the predetermined options from the menu. In the exemplary screen shown in FIG. 4, the administrator has selected “Liens” for the “Line of Business” stamp identification characteristic. The administrator has also selected “1” as the document “Page No.” on which the stamp will appear, has selected a “Border Width” of “1,” has selected “Arial” for the “Font,” and has selected a “Line” and “Position” for each of “Secretary Name,” “File No.,” and “Filing Date.” The administrator has also selected “Notes 1,” “Notes 2,” and “Notes 3” as shown. As such in Line 1, Position 1 the electronic stamp will read “File Number:,” in Line 1, Position 2 the file number associated with the document will be provided, in Line 2, Position 1 the electronic stamp will read “Date Filed:,” in Line 2, Position 2 the filing date associated with the document will be provided, in Line 3, Position 1 the secretary name will be provided, and in Line 4, Position 1 the electronic stamp will read “Secretary of State.”

As shown in association with the stamp identification characteristic “Name” and the stamp placement characteristics “Stamp Width,” “Stamp Height” and the location coordinates “Start X” and “Start Y”, a fillable field is provided. The user then makes a selection by inputting a text entry into the fillable field. In the exemplary screen shown in FIG. 4, the administrator has selected “Liens Electronic Stamp” as the “Name” identification characteristic. The administrator has also selected a “Stamp Width” of 70 mm, a “Stamp Height” of 30 mm, and has selected the (x,y) coordinates for the stamp location on a document page as (130, 10), which means the stamp will begin 130 mm from the left edge of the document page and 10 mm down from the top edge of the document page. Other measures, such as inches or pixels, may be used in place of millimeters to define the stamp location.

As shown in association with stamp content characteristics “SOS Office,” “Secretary Name,” “File No.,” “Arrival Date/Time,” “Filing Date,” “Notes 1,” “Notes 2,” and “Notes 3,” a checkbox is provided. The user then makes a selection by checking the appropriate box. In the exemplary screen shown in FIG. 4, the administrator has selected “Secretary Name,” “File No.,” “Filing Date,” and “Notes” 1, 2, and 3 for inclusion in the electronic stamp. The checkbox method allows all the characteristics or options to be visible while only those selected by the administrator will be part of the final electronic stamp configuration.

Of course, alternative methods for making, electronic stamp characteristic selections are also within the scope of the present invention, such as marking a circle or radio button (as shown in association with the “Page No.” and “Last Page” electronic stamp characteristic in FIG. 4), actuating a button (as shown in association with the font style formatting characteristics in FIG. 4), or selecting indicators such as “yes” or “no,” or “on” or “off” for each characteristic. Additionally, all the selection methods described above may be used for any of the electronic stamp characteristic selections.

With reference to FIG. 2 at block 38, the administrator saves the stamp identification characteristic selections, stamp placement characteristic selections, and stamp content characteristic selections as an electronic stamp configuration in a database on database server(s) 18. As shown in the exemplary “configure stamp” detail screen in FIG. 4, the electronic stamp configuration may be saved by selecting a “save” button such as a disc icon. A “save and add new” button may also be provided, which would allow a user to save the configuration for the current stamp and then immediately open a new “configure stamp” detail screen to create a new stamp configuration. Alternatively, the administrator may exit the “configure stamp” detail screen without saving her selections by selecting an “exit” button, such as an arrow icon. The administrator may also delete the stamp configuration from a database on database server(s) 18 altogether by selecting a “delete” button such as an “X” icon.

With reference to FIG. 2 at block 32, the administrator may alternatively choose to edit an existing electronic stamp configuration. If the administrator chooses to edit an existing electronic stamp configuration, the previous selections for that particular stamp may be displayed in a format similar to the one shown in FIG. 4. With reference to blocks 34 and 36 in FIG. 2, the administrator may make the appropriate edits and then select a “save” button to save her changes to that particular configuration. Likewise, the administrator may delete the stamp configuration or exit the “configure stamp” detail screen without saving her changes or deleting the existing configuration.

Referring now to FIG. 5, a process flow diagram that shows an exemplary method of applying a configured electronic stamp to a document using system 10 of FIG. 1 is provided. Typically, an office or organization, such as a secretary of state office, handles a variety of different types of documents, such as documents received from third parties (e.g., applications for registration, lien submissions, and requests for certified copies) and/or documents generated while processing or tracking other documents (e.g., invoices, orders, receipts, billing statements, and receivable statements).

A document may be initially received by or entered into system 10 in any one of a variety of ways. If a paper document is received, an electronic image is created by scanning the document. At the time the electronic image of the document is created, basic filing or document information such as document type, arrival time, and arrival date may be automatically recorded and associated with the document image. Additional document information may be captured through manual data entry or use, of optical scanning technologies, such as OCR. Alternatively, a document may be initially received via a web-based filing or processing system. In this case, the document may be created by system 10 in electronic form after much of the basic filing/document information has been entered by the filer/document information recorder during the submission process. Additional document information may be automatically generated and captured by system 10 at the time of creation. Often there is no manual data entry step performed by an office employee after the filer/document information recorder has entered the required information and the document is created by the system, but additional document information may be manually entered once the document is created. A document may also be initially received in electronic form by uploading, impeding, or otherwise electronically transmitting it into system 10. At the time the electronic document is transmitted, basic filing or document information such as, document type, arrival, time, and arrival date, and document information entered by the filer/document information recorder may be automatically recorded or captured and associated with the document image. Additional document information may be captured through manual data entry or use of OCR after the document is transmitted.

Regardless of whether the document is submitted in paper form, via a web-based filing or document submission system, or by transmission of an electronic version of the document, an electronic image of the document and its associated document information is stored in a database on database server(s) 18. The document information may include, for example, an office designation, a name, a file number, a document number, an invoice number, a receipt number, an arrival date, an arrival time, a filing date, a filing time, a registration number, an application number, registration date, a renewal date, relevant individual or entity name(s), an expiration date, and one or more notes. Of course, other types of document information are within the scope of the present invention.

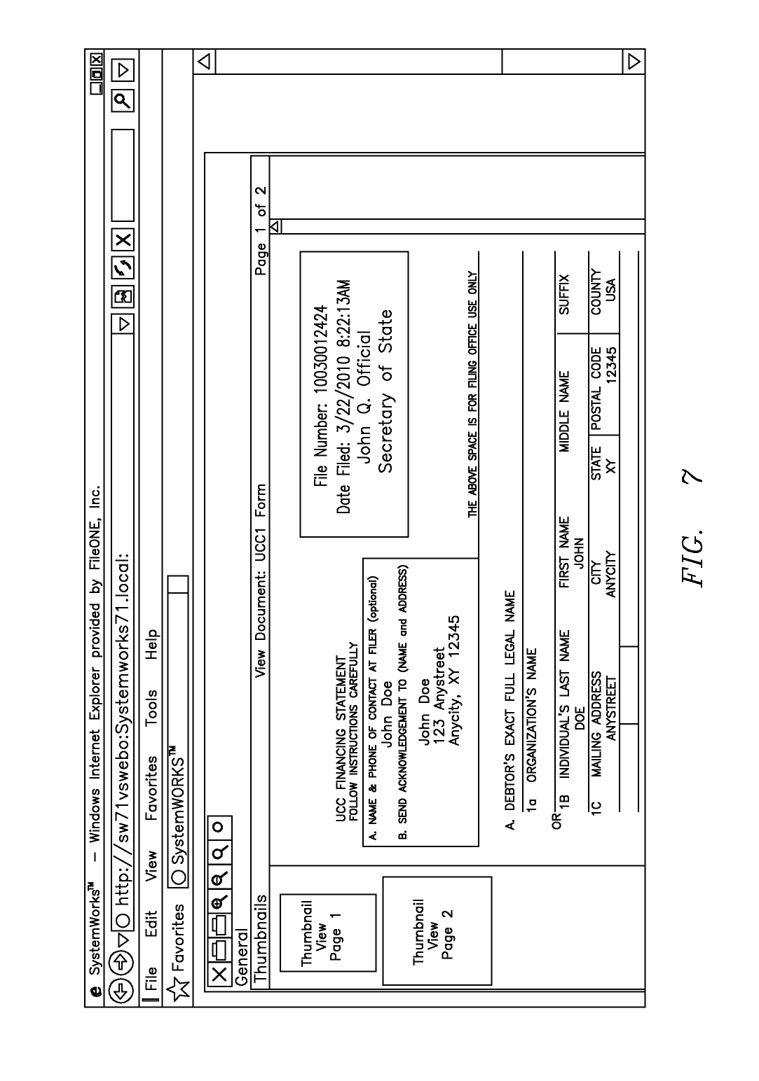

With reference to FIG. 5 at blocks 40 and 42, the electronic image of the document is retrieved and reviewed by an employee (e.g., via one of workstations 12 or remote computers 14) using the “Verification” function. As shown in the exemplary “verification” screen in FIG. 6, the document image may be provided along with document information previously associated with the image, such as arrival date/time and document type. The employee reviewing or verifying the document may be permitted, to change previously entered document information and/or may be required to enter additional information about the document as she completes her review. As shown in FIG. 6, the employee may be, required to provide information as prompted under several different reviewing tabs such as “Filing Details,” “Debtor,” “Secured Party,” “Collateral” and “Real Estate.” Other reviewing tabs may be provided depending on the type of document under review or the office or organization with which the document was filed. As discussed below, the document information entered by the reviewer may later be merged into the electronic stamp for that document as dictated by the selections that were made for the stamp configuration.

With reference, to FIG. 5 at block 44, the employee reviewing the document may choose to accept or reject the document. As shown in FIG. 6, the document may be accepted or rejected by selecting an “Accept” or “Reject” button. The process for accepting a document may include additional prompts for the reviewer to enter any additional document information required by the electronic stamp configuration, such as customizable text. The acceptance process may also include generating a unique document identification code that will be merged into the electronic stamp. The reviewer may be presented with a preview of the electronic stamp before completing the acceptance process and may be given the option to further edit some or all of the document information provided in the stamp. The reviewer may also be presented with a screen displaying a preview of the document with the embedded stamp. Optionally, the user may further configure the location of the stamp by using a drag and drop tool or by editing the x and y coordinates for the stamp.

It should be understood that the document information required by a particular electronic stamp configuration may be obtained from various sources. Some document information will be entered by the reviewer during the acceptance process and stored in a database on database server(s) 18. Other document information will have been previously entered or captured and stored in a database on database server(s) 18, such as basic filing or document information entered upon submission or receipt of the document or general information (e.g., the name of the current Secretary of State). Yet other document information will be automatically generated using appropriate algorithms based on stored document information. For example, a checksum figure may be generated for the filing or document, or a sequential identification number may be generated. Many electronic stamp configurations will require a combination of two or more of these document information source options. In all of these cases, the application server(s) 16 retrieve document information corresponding to the selected electronic stamp characteristics from a database on database server(s) 18 and incorporate the document information into the electronic stamp in accordance with the electronic stamp configuration.

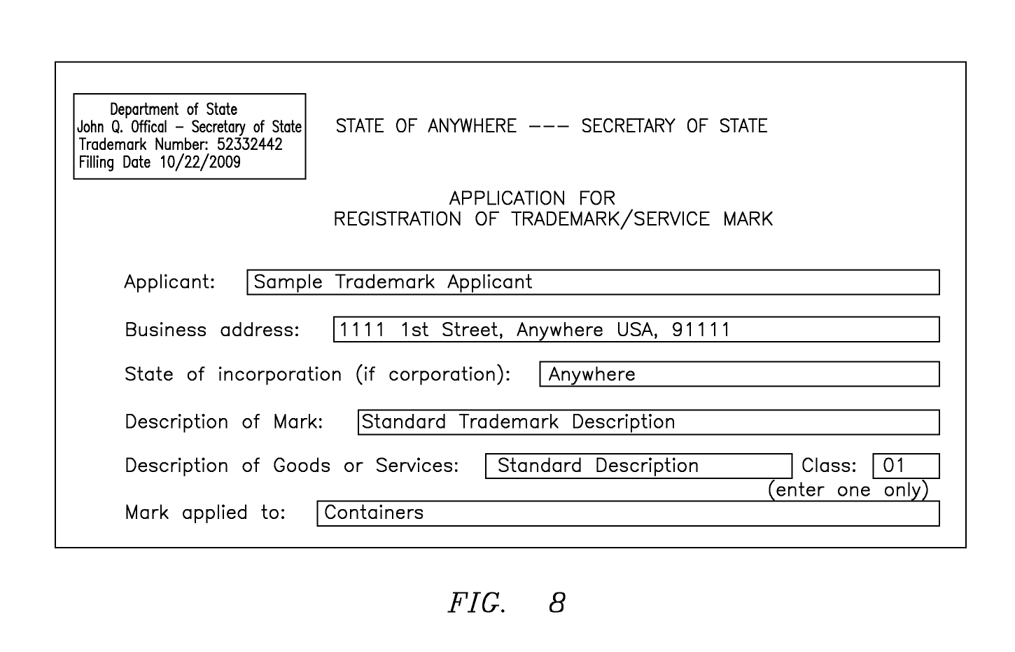

With reference to FIG. 5 at block 44, after the acceptance process described above is complete, the electronic stamp is permanently associated with the electronic document image and the document may be subject to additional processing in accordance with office procedure. Exemplary documents displaying different exemplary electronic stamps are shown in FIGS. 7 and 8. As shown in FIG. 7, the electronic stamp is viewable in the upper right-hand corner of a document viewed on a display screen. As shown in FIG. 8, the electronic stamp is viewable in the upper left-hand corner of a printed document.

While the present invention has been described and illustrated hereinabove with reference to an exemplary embodiment, it should be understood that various modifications could be made to this embodiment without departing from the scope of the invention. For example, while the application process of the exemplary embodiment involves applying the electronic stamp to the document after a single review step, the electronic stamp could alternatively be applied to the document after other steps of the overall process (e.g., upon manual entry or generation of the basic filing/document information or after a subsequent review step). Therefore, the invention is not to be limited to the exemplary embodiment described and illustrated hereinabove, except insofar as such limitations are included in the following claims.

What is claimed and desired, to be secured by Letters Patent is as follows:

1. A computer-implemented method for configuring one or more electronic stamps to be applied to documents in electronic form, comprising:
providing a user interface that enables a user to create or edit an electronic stamp configuration by displaying a plurality of electronic stamp characteristics and receiving a plurality of electronic stamp characteristic selections corresponding to said electronic stamp characteristics; and
storing said electronic stamp characteristic selections so as to define said electronic stamp configuration.

2. The computer implemented method of claim 1, wherein said electronic stamp characteristics comprise one or more of the following: one or more stamp placement characteristics; one or more stamp content characteristics, and one or more stamp identification characteristics.

3. The computer-implemented method of claim 2, wherein said stamp placement characteristics comprise one or more of the following: a stamp height; a stamp width; a page number of a document on which an electronic stamp appears; and a location in which an electronic stamp appears on a page of a document.

4. The computer-implemented method of claim 2, wherein said stamp content characteristics comprise one or more of the following: an office designation; a name; a file number; a document number; an invoice number; a receipt number; an arrival date; an arrival time; a filing date; a filing time; a registration number; an application number; a registration date; a renewal date; an individual or entity name; an expiration date; a note; a border type; and a border width.

5. The computer-implemented method of claim 4, wherein said electronic stamp characteristics comprise one or more formatting characteristics associated with one or more of said stamp content characteristics, wherein said formatting characteristics comprise one or more of the following: a font; a font size; a font style; a line on which a selected stamp content characteristic appears in an electronic stamp; a position in which a selected stamp content characteristic appears on a line in an electronic stamp; and an alignment option.

6. The computer-implemented method of claim 2, wherein said stamp identification characteristics comprise one or more of the following: a stamp name; an office in which an electronic stamp is used; a line of business in which an electronic stamp is used; and a document type on which an electronic stamp is used.

7. The computer-implemented method claim of claim 1, wherein said user interface enables said user to create or edit said electronic stamp configuration by displaying one or more pre-determined options associated with at least one of said electronic stamp characteristics.

8. The computer-implemented method of claim 7, wherein at least one of said electronic stamp characteristic selections comprises a selection made by said user from said pre-determined options.

9. The computer-implemented method of claim 1, wherein said user interface enables said user to create or edit said electronic stamp configuration by displaying a tillable field associated with at least one of said electronic, stamp characteristics.

10. The computer-implemented method of claim 9, wherein at least one of said electronic stamp characteristic selections comprises a text entry entered by said user in said tillable field.

11. The computer-implemented method of claim 1, wherein said user interface enables said user to create or edit said electronic stamp configuration by displaying a checkbox for at least one of said electronic stamp characteristics.

12. The computer-implemented method of claim 11, wherein at least one of said electronic stamp characteristic selections comprises a check entered by said user in said checkbox.

13. The computer-implemented, method of claim 2, wherein said user interface enables said user to review a summary of said electronic stamp configuration.

14. The computer-implemented-method of claim 13, wherein said summary of said electronic stamp configuration comprises one or more of said electronic stamp characteristics and associated electronic stamp characteristic selections for said electronic stamp configuration.

15. The computer-implemented method of claim 1, further comprising using said electronic stamp configuration to generate an electronic, stamp that is applied to a document in electronic form.

16. The computer-implemented method of claim 15, further comprising storing document information associated with said document.

17. The computer-implemented method of claim 16, wherein said document information comprises one or more of the following: an office designation; a name; a file number; a document number; an invoice number; a receipt number; an arrival date; an arrival time; a filing date; a filing tittle; a registration number; an application number; a registration date; a renewal date; an expiration date; and a note.

18. The computer-implemented method of claim 16, further comprising retrieving document information corresponding to at least one of said electronic stamp characteristic selections and incorporating said document information into said electronic stamp in accordance with said electronic stamp configuration.

19. A system for configuring one or more electronic stamps to be applied to documents in electronic form, comprising:
at least one database server; and
at least one application server in communication with said database server, wherein said application server:
provides a user interface that enables a user to create or edit an electronic stamp configuration, wherein said user interface (i) displays a plurality of electronic stamp characteristics and (ii) receives a plurality of electronic stamp characteristic selections corresponding to said electronic stamp characteristics; and
stores said electronic stamp characteristic selections in said database server so as to define said electronic stamp configuration.

20. The system of claim 19, wherein said electronic stamp characteristics comprise one or more of the following: one or more stamp placement characteristics; one or more stamp content characteristics, and one or more stamp identification characteristics.

21. The system of claim 20, wherein said stamp placement characteristics comprise one or more of the following: a stamp height; a stamp width; a page number of a document on which an electronic stamp appears; and a location in which an electronic stamp appears on a page of a document.

22. The system of claim 20, wherein said stamp content characteristics comprise one or more of the following: an office, designation; a name; a file number; a document number; an invoice number; a receipt number; an arrival date; an arrival time; a filing date; a filing time; a registration number; an application number; a registration date; a renewal date; an individual or entity name; an expiration date; a note; a border type; and a border width.

23. The system of claim 22, wherein said electronic stamp characteristics comprise one or more formatting characteristics associated with one or more of said stamp content characteristics, wherein said formatting characteristics comprise one or more of the following: a font; a font size; a font style; a line on which a selected stamp content characteristic appears in an electronic stamp; a position in which a selected stamp content characteristic appears on a line in an electronic stamp; and an alignment option.

24. The system of claim 20, wherein said stamp identification characteristics comprise one or more of the following: a stamp name; an office in which an electronic stamp is used; a line of business in which an electronic stamp is used; and a document type on which an electronic stamp is used.

25. The system of claim 19, wherein said user interface displays one or more pre-determined options associated with, at least one of said electronic stamp characteristics.

26. The system of claim 25, wherein at least one of said electronic stamp characteristic selections comprises a selection made by said user from said pre-determined options.

27. The system of claim 19, wherein said user interface displays a tillable field associated with at least one of said electronic stamp characteristics.

28. The system of claim 27, wherein at least one of said electronic stamp characteristic selections comprises a text entry entered by said user in said fillable field.

29. The system of claim 19, wherein said user interface displays a checkbox for at least one of said electronic stamp characteristics.

30. The system of claim 29, wherein at least one of said electronic stamp characteristic selections comprises a check entered by said user in said checkbox.

31. The system of claim 19, wherein said user interface displays a summary of said electronic stamp configuration.

32. The system of claim 31, wherein said summary of said, electronic stamp configuration comprises one or more of said electronic stamp characteristics and associated electronic stamp characteristic selections for said electronic stamp configuration.

33. The system of claim 19, wherein said application server uses said electronic stamp configuration to generate an electronic stamp that is applied to a document in electronic form.

34. The system of claim 33, wherein said database server also stores document information associated with said document.

35. The system of claim 34, wherein said document information comprises one or more of the following: an office designation; a name; a file number; a document number; an invoice number; a receipt number; an arrival date; an arrival, time; a filing date; a filing time; a registration number; an application number; a registration date; a renewal date; an expiration date; and a note.

36. The system of claim 34, wherein said application server retrieves document information corresponding to at least one of said electronic stamp characteristic selections from said database server and incorporates said document information into said electronic stamp in accordance with said electronic stamp configuration.

37. The system of claim 19, wherein said database server and said application server comprise a single server.

38. A computer-readable medium having instructions stored thereon for execution by a processor to perform a method for configuring one or more electronic stamps to be applied to documents in electronic form, the method comprising:
displaying a plurality of electronic stamp characteristics;
receiving a plurality of electronic stamp characteristic selections corresponding to said electronic stamp characteristics; and
storing said electronic stamp characteristic selections so as to define an electronic stamp configuration.

39. The computer-readable medium of claim 38, wherein said electronic stamp characteristics comprise one or more of the following: one or more stamp placement characteristics; one or more stamp content characteristics, and one or more stamp identification characteristics.

40. The computer-readable medium of claim 39, wherein said stamp placement characteristics comprise one or more of the following: a stamp height; a stamp width; a page number of a document on which an electronic stamp appears; and a location in which an electronic stamp appears on a page of a document.

41. The computer-readable medium of claim 39, wherein said stamp content characteristics comprise one or more of the following: an office designation; a name; a file number; a document number; an invoice number; a receipt number; an arrival date; an arrival time; a filing date; a filing time; a registration number; an application number; a registration date; a renewal date; an individual or entity name; an expiration date; a note; a border type; and a border width.

42. The computer-readable medium of claim 41, wherein said electronic stamp characteristics comprise one or more formatting characteristics associated with one or more of said stamp content characteristics, wherein said formatting characteristics comprise one or more of the following: a font; a font size; a font style; a line on which a selected stamp content characteristic appears in an electronic stamp; a position in which a selected stamp content characteristic appears on a line in an electronic stamp; and an alignment option.

43. The computer-readable medium of claim 39, wherein said stamp identification characteristics comprise one or more of the following: a stamp name; an office in which an electronic stamp is used; a line of business in which an electronic stamp is used; and a document type on which an electronic stamp is used.

44. The computer-readable medium of claim 38, further comprising displaying one or more pre-determined options associated with at least one of said electronic stamp characteristics.

45. The computer-readable medium of claim 44, wherein at least one of said electronic stamp characteristic selections comprises a selection made by a user from said pre-determined options.

46. The computer-readable medium of claim 38, further comprising displaying a tillable field associated with at least one of said electronic stamp characteristics.

47. The computer-readable medium of claim 46, wherein at least one of said electronic stamp characteristic selections comprises a text entry entered by a user in said finable field.

48. The computer-readable medium of claim 38, further comprising displaying a checkbox for at least one of said electronic stamp characteristics.

49. The computer-readable medium of claim 48, wherein at least one of said electronic stamp characteristic selections comprises a check entered by a user in said checkbox.

50. The computer-readable medium of claim 38, further comprising displaying a summary of said electronic stamp configuration.

51. The computer-readable medium of claim 50, wherein said summary of said electronic stamp configuration comprises one or more of said electronic stamp characteristics and associated, electronic stamp characteristic selections for said electronic stamp configuration.

52. The computer-readable medium of claim 38, further comprising using said electronic stamp configuration to generate an electronic stamp and applying said electronic stamp to a document in electronic form.

53. The computer-readable medium of claim 52, further comprising storing document information associated with said document.

54. The computer-readable medium of claim 53, wherein said document information comprises one or more of the following: an office designation; a name; a file number; a document number; an invoice number; a receipt number; an arrival date; an arrival time; a filing date; a filing time; a registration number; an application number; a registration date; a renewal date; an expiration date; and a note.

55. The computer-readable medium of claim 53, further comprising retrieving document information corresponding to at least one of said electronic stamp characteristic selections and incorporating said document information into said electronic stamp in accordance with said electronic stamp configuration.
